(19) United States
(12) Patent Application Publication
(10) Pub. No.: US 2023/0172164 A1
(43) Pub. Date: Jun. 8, 2023

(54) SPLIT-TYPE PET TRACTION HARNESS

(71) Applicant: ZeShan Guo, Jiangsu Province (CN)

(72) Inventor: ZeShan Guo, Jiangsu Province (CN)

(21) Appl. No.: 17/555,527

(22) Filed: Dec. 20, 2021

(30) Foreign Application Priority Data
Dec. 8, 2021 (CN) 202123067792.9

(51) Int. Cl. A01K 27/00

(52) U.S. Cl. CPC A01K 27/002

(57) ABSTRACT

The present application provides a split-type pet traction harness. The first body and the second body have a combined state for wearing on a pet and a split state for realizing quick putting-on. The first body and the second body realize switching between the combined state and the split state by means of a movable connector. In the combined state, the first body and the second body form a first opening for a pet trunk to pass through, a second opening for pet head and neck to pass through, and a third opening and a fourth opening for pet forelimbs to pass through. By configuring the pet harness to be a split-type structure, the product can realize quick putting-on without a pullover manner, leading to convenience in the putting-on process and in adjustment, and thus is applicable to pets of different sizes. Moreover, the stress structure of the back saddle is improved such that the stress is transferred from the fabric to the woven strap, thereby dispersing the tension to protect the pet neck and preventing the binding from break due to the excessive tension applied to the fabric. In addition, the product is made a high quality material, so that the pet feels comfortable when wearing the product and it is not easy to damage the product.

### TECHNICAL FIELD

The present application relates to pet supplies, in particular to a split-type pet traction harness.

### BACKGROUND

At present, the existing pet harnesses in the market each have an integrated structure, and may be put on by a pet only in a pullover manner, thereby causing great inconvenience in the putting-on process. In addition, the stress structure of the back saddle of the conventional pet harness is uneven, and thus cannot effectively disperse the tension to protect the pet neck when the pet pulls the harness; the binding may break due to the excessive tension applied to the fabric. Moreover, during the process of putting on the conventional dog harness, it is easy to abrade the inner sides of the pet front legs, the quality is poor, and the damage is easy to occur, thus having many disadvantages.

### SUMMARY

In view of the defects of the prior art, the present application provides a split-type pet traction harness.

In order to achieve the objective, the present application adopts the following technical solution: a split-type pet traction harness, including a first body and a second body, wherein the first body and the second body have a combined state for wearing on a pet and a split state for realizing quick putting-on, and the first body and the second body realize switching between the combined state and the split state by means of a movable connector.

In the combined state, the first body and the second body form a first opening for a pet trunk to pass through, a second opening for pet head and neck to pass through, and a third opening and a fourth opening for pet forelimbs to pass through.

The movable connector includes a plug-in portion and a socket portion, the socket portion is connected to the first body, the plug-in portion is connected to the second body by means of an adjusting strap, and the sizes of the first opening, the second opening, the third opening, and the fourth opening change with the adjustment of the adjusting strap.

In the split state of the first body and the second body, the first body has four connecting portions, the second body is correspondingly provided with four corresponding connecting portions, socket ends of the movable connectors are respectively connected to the four connecting portions of the first body, and plug-in ends of the movable connectors are respectively connected to the four connecting portions of the second body.

The first body is connected to a traction buckle by means of a woven strap, and the woven strap is sewn on the first body by means of needlework.

The first body is provided with a handhold portion, and two ends of the handhold portion are sewn and fixed on the first body by means of needlework.

The handhold portion is made of a synthetic rubber foam material.

A binding made of a soft material is sewn on the edges of the first body and the second body by means of needlework.

The first body and the second body are made of an Oxford waterproof twill fabric.

The adjusting strap is provided with an adjusting buckle.

The present application ahs the following beneficial effects: the present application provides a split-type pet traction harness. By configuring the pet harness to be a split-type structure, the product can realize quick putting-on without a pullover manner, leading to convenience in the putting-on process and in adjustment, and thus is applicable to pets of different sizes. Moreover, the stress structure of the back saddle is improved such that the stress is transferred from the fabric to the woven strap, thereby dispersing the tension to protect the pet neck and preventing the binding from break due to the excessive tension applied to the fabric. In addition, the product is made a high quality material, so that the pet feels comfortable when wearing the product and it is not easy to damage the product.

The present application also has the characteristics of a simple structure, convenience in manufacturing, and easiness in assembling, and has strong practicability.

### DESCRIPTION OF THE DRAWINGS

FIG. 1 is a schematic structural diagram of a combined state according to the present application.

FIG. 2 is a schematic structural diagram of a split state according to the present application.

FIG. 3 is a schematic structural diagram of a first body according to the present application.

FIG. 4 is a schematic structural diagram of a second body according to the present application.

### DESCRIPTION OF THE EMBODIMENTS

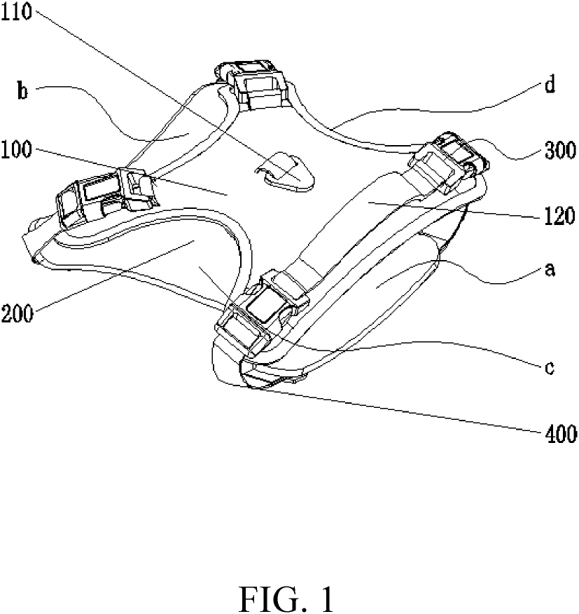

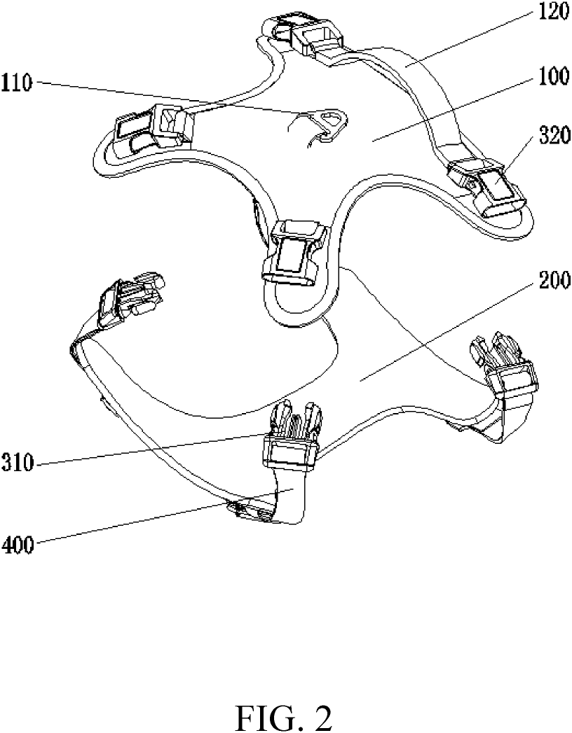

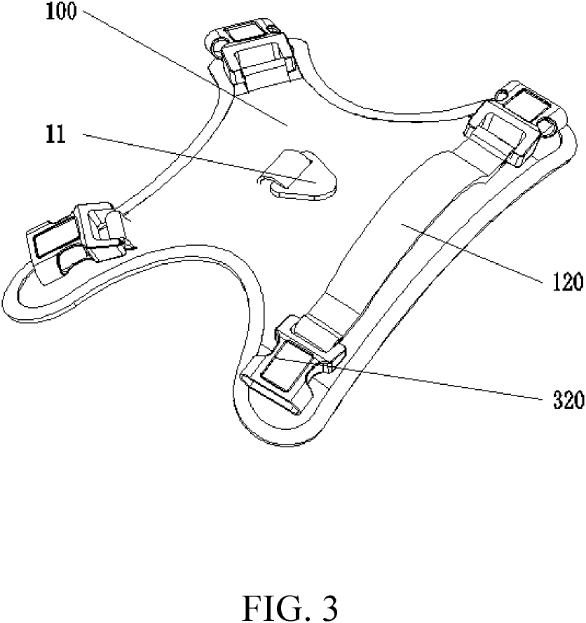

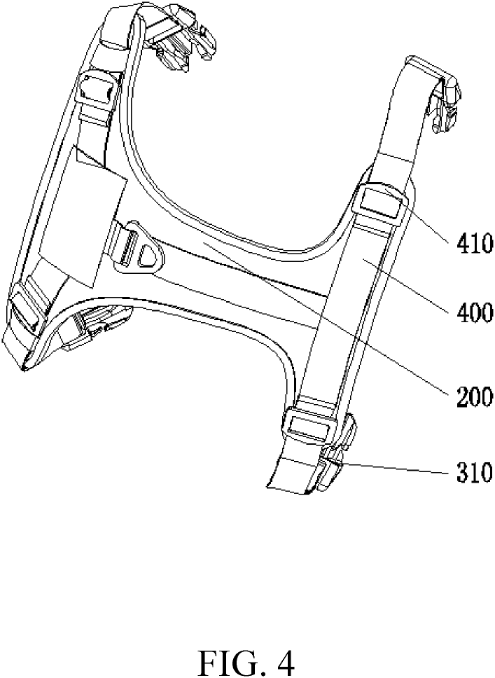

Referring to FIG. 1 to FIG. 4, a split-type pet traction harness includes a first body 100 and a second body 200. The first body 100 and the second body 200 have a combined state for wearing on a pet and a split state for realizing quick putting-on, and the first body 100 and the second body 200 realize switching between the combined state and the split state by means of a movable connector 300. The conventional pet harness has an integrated structure, and may be put on by buckling from one side in a pullover manner, causing inconvenience in the putting-on process. In this embodiment, the traction harness is configured to be a split-type structure. The first body 100 is a back saddle, and the second body 200 is an abdominal saddle, which are connected and assembled by means of the movable connector 300, thereby achieving free assembly and disassembly and convenient and quick putting-on.

In the combined state, the first body 100 and the second body 200 form a first opening a for a pet trunk to pass through, a second opening b for pet head and neck to pass through, and a third opening c and a fourth opening d for pet forelimbs to pass through. This product is mainly sleeved on the pet anterior trunk and restricted by the two forelimbs, so as to prevent the harness from detaching from the pet body.

The movable connector 300 includes a plug-in portion 310 and a socket portion 320, the socket portion 320 is connected to the first body 100, the plug-in portion 310 is connected to the second body 200 by means of an adjusting strap 400, and the sizes of the first opening a, the second opening b, the third opening c, and the fourth opening d change with the adjustment of the adjusting strap 400. The movable connector 300 and the adjusting strap 400 are common adjusting plug-in and socket structures, which are commonly used on backpacks. The combined assembly of the first body 100 and the second body 200 is realized by means of plug-in fitting, and the size is adjusted by means of the adjusting strap 400, so as to adapt to pets of different sizes.

In the split state of the first body 100 and the second body 200, the first body 100 has four connecting portions, the second body 200 is correspondingly provided with four corresponding connecting portions, socket ends of the movable connectors 300 are respectively connected to the four connecting portions of the first body 100, plug-in ends of the movable connectors 300 are respectively connected to the four connecting portions of the second body 200, and the four connecting portions protrude from the body to form recesses. When the first body 100 and the second body 200 are fit, the recesses form openings.

The first body 100 is connected to a traction buckle 110 by means of a woven strap, the woven strap is sewn on the first body 100 by means of needlework, and the traction buckle 110 is used to connect a traction rope. The conventional traction buckle 110 is fixed on a binding. When the harness is used on large dogs, the binding may often be tore by the traction buckle 110. In this embodiment, the traction buckle 110 is sewn on the first body 100 by means of the woven strap to achieve a better stress effect, so that the damage is difficult to occur.

The first body 100 is provided with a handhold portion 120, two ends of the handhold portion 120 are sewn and fixed on the first body 100 by means of needlework, and the handhold portion 120 is used for a pet owner to control the pet when mounting or detaching the traction rope, and may also be firmly held by a hand when the pet is emotional, so as to prevent the pet from running about.

The handhold portion 120 is made of a synthetic rubber foam material. The handhold portion 120 is made of neoprene to improve the holding comfort.

A binding made of a soft material is sewn on the edges of the first body 100 and the second body 200 by means of needlework. The binding is improved to be made of a softer material, which is not easy to scratch the inner sides of the dog front legs due to friction.

The first body 100 and the second body 200 are made of an Oxford waterproof twill fabric. The overall fabric is 1680D twill, which has higher strength and better wear resistance than an old model.

The adjusting strap 400 is provided with an adjusting buckle 410. The adjusting buckle 410 is used in cooperation with the adjusting strap 400 and is a very mature structure at present, which is not repetitively described herein.

The present application provides a split-type pet traction harness. By configuring the pet harness to be a split-type structure, the product can realize quick putting-on without a pullover manner, leading to convenience in the putting-on process and in adjustment, and thus is applicable to pets of different sizes. Moreover, the stress structure of the back saddle is improved such that the stress is transferred from the fabric to the woven strap, thereby dispersing the tension to protect the pet neck and preventing the binding from break due to the excessive tension applied to the fabric. In addition, the product is made a high quality material, so that the pet feels comfortable when wearing the product and it is not easy to damage the product.

The above description illustrates and describes the basic principle, main features, and advantages of the present application. Those skilled in the art should understand that the present application is not limited by the above embodiments. The above embodiments and description only describe the principle of the present application. Without departing from the spirit and scope of the present application, simple changes and replacement made by those skilled in the art still fall within the protection scope of the present application.

1. A split-type pet traction harness, comprising a first body and a second body, wherein the first body and the second body have a combined state for wearing on a pet and a split state for realizing quick putting-on, and the first body and the second body realize switching between the combined state and the split state by means of a movable connector.

2. The split-type pet traction harness according to claim 1, wherein in the combined state, the first body and the second body form a first opening for a pet trunk to pass through, a second opening for pet head and neck to pass through, and a third opening and a fourth opening for pet forelimbs to pass through.

3. The split-type pet traction harness according to claim 2, wherein the movable connector comprises a plug-in portion and a socket portion, the socket portion is connected to the first body, the plug-in portion is connected to the second body by means of an adjusting strap, and the sizes of the first opening, the second opening, the third opening, and the fourth opening change with the adjustment of the adjusting strap.

4. The split-type pet traction harness according to claim 3, wherein in the split state of the first body and the second body, the first body has four connecting portions, the second body is correspondingly provided with four corresponding connecting portions, socket ends of the movable connectors are respectively connected to the four connecting portions of the first body, and plug-in ends of the movable connectors are respectively connected to the four connecting portions of the second body.

5. The split-type pet traction harness according to claim 1, wherein the first body is connected to a traction buckle by means of a woven strap, and the woven strap is sewn on the first body by means of needlework.

6. The split-type pet traction harness according to claim 1, wherein the first body is provided with a handhold portion, and two ends of the handhold portion are sewn and fixed on the first body by means of needlework.

7. The split-type pet traction harness according to claim 6, wherein the handhold portion is made of a synthetic rubber foam material.

8. The split-type pet traction harness according to claim 1, wherein a binding made of a soft material is sewn on the edges of the first body and the second body by means of needlework.

9. The split-type pet traction harness according to claim 1, wherein the first body and the second body are made of an Oxford waterproof twill fabric.

10. The split-type pet traction harness according to claim 3, wherein the adjusting strap is provided with an adjusting buckle.
